(19) United States
(12) Patent Application Publication
(10) Pub. No.: US 2019/0045476 A1
(43) Pub. Date: Feb. 7, 2019

(54) USER DEVICE AND MESSAGE FORWARDING METHOD

(71) Applicant: NUBIA TECHNOLOGY CO., LTD., Shenzhen (CN)

(72) Inventors: Jian HE, Shenzhen (CN); Zudong LUO, Shenzhen (CN); Zhao WANG, Shenzhen (CN)

(21) Appl. No.: 16/073,053

(22) PCT Filed: Jul. 29, 2016
(86) PCT No.: PCT/CN2016/092214

§ 371 Date: Jul. 26, 2018

(30) Foreign Application Priority Data
Jan. 27, 2016 (CN) 201610058227.0

(51) Int. Cl. H04W 60/04; H04L 12/741; H04W 72/04

(52) U.S. Cl. CPC H04W 60/04; H04W 4/20; H04W 72/048; H04L 45/745

(57) ABSTRACT

The present invention discloses a user device and a message forwarding method. The message forwarding method, applied to the user device including a first application service processor and a second application service process, includes the following steps. The second application service processor receives a message sent by the first application service processor, identifies a destination address included in the message, and forwards the message to a destination device according to the destination address.

This application is a national phase of PCT application No. PCT/CN2016/092214, filed on Jul. 29, 2016, which claims the priority of Chinese Patent Application No. CN201610058227.0, filed on Jan. 27, 2016, the entire content of all of which is incorporated herein by reference.

### FIELD OF THE INVENTION

The present invention generally relates to the field of communication technology and, more particularly, relates to a user device and a message forwarding method.

### BACKGROUND

With the development of mobile communication technology, advanced cellular networks, e.g., networks based on the long term evolution (LTE) standard (a standard adopted by some “4G” networks), are being deployed all over the world. Due to the introduction of key technologies such as orthogonal frequency division multiplexing (OFDM), multi-input & multi-output (MIMO), etc., using 4G-related standards can significantly improve spectral efficiency and data transmission speed.

On the other hand, while the network speed and the band utilization are getting improved, the emergence of multi-mode user devices (user devices that have two user identification cards, for example, dual-card dual-active user devices) allow users to establish data service connection while having standby voice services.

An existing user device typically includes a modem processor and an application service processor. Between the two, the modem processor is used for performing protocol processing, and also for modulating and demodulating the transmitting and the receiving communication data so that various functions such as communication with an external communication device, etc., may be implemented. The application service processor is used for processing complex logic operations and task allocation, providing the user with an interactive interface, running the operating system, etc.

In order to extend the communication functions for mobile terminals, when adding a new modem processor and an application service processor is required, the existing technology does not provide any solution on how to implement data transmission and forwarding between the original application service processor and the new application service processor to realize the corresponding communication function.

The existing technology has drawbacks and needs to be improved.

### BRIEF SUMMARY OF THE INVENTION

The technical problem to be solved by the present invention is to provide a user device and a message forwarding method to counter the above drawbacks in the existing technology.

The technical solution adopted by the present invention to solve the technical problem includes the followings.

In a first aspect, a message forwarding method is provided. The message forwarding method is applied to a user device that includes a first application service processor and a second application service processor. The message forwarding method includes the following steps:
the second application service processor receives a message sent by the first application service processor, identifies a destination address included in the message, and forwards the message to a destination device according to the destination address.

In one embodiment, the destination device includes a modem processor connected to the second application service processor, a WIFI module connected to the second application service processor.

In one embodiment, the destination address includes an IP address and a subnet mask.

In one embodiment, the WIFI module provides a WIFI data channel.

In one embodiment, the method further includes that:
the second application service processor receives the message sent by the first application service processor, and forwards the message to the modem processor for data transmission according to the destination address; or
the second application service processor receives the message sent by the first application service processor, and forwards the message to the WIFI module for data transmission according to the destination address; or
the second application service processor distributes the message to the modem processor and the WIFI module for concurrent data transmission according to the traffic allocation.

In one embodiment, the WIFI module is used as a hotspot.

In one embodiment, the second application service processor determines whether to send the message to the modem processor or to send the message to the WIFI module according to the subnet mask in the destination address.

In a second aspect, a user device is provided. The user device includes a first application service processor and a second application service processor;

The first application service processor is configured to send a message to the second application service processor;

The second application service processor is used to receive the message sent by the first application service processor, identify a destination address included in the message, and forward the message to a destination device according to the destination address.

In one embodiment, the destination device includes a modem processor connected to the second application service processor, a WIFI module connected to the second application service processor.

In one embodiment, the destination address includes an IP address and a subnet mask.

In one embodiment, the WIFI module provides a WIFI data channel.

In one embodiment, the user device further includes that:
the second application service processor is used to receive the message sent by the first application service processor, and forward the message to the modem processor for data transmission according to the destination address; or
the second application service processor is used to receive the message sent by the first application service processor, and forward the message to the WIFI module for data transmission according to the destination address; or
the second application service processor is used to distribute the message to the modem processor and the WIFI module for concurrent data transmission according to the traffic allocation.

In one embodiment, the WIFI module is used as a hotspot.

In one embodiment, the second application service processor is used to determine whether to send the message to the modem processor or to send the message to the WIFI module according to the subnet mask in the destination address.

In one embodiment, the user device further includes:
a first user identification card;
a second user identification card;
a first modem processor;
a second modem processor.

The first user identification card and the second user identification card are both connected to the first modem processor, and the first modem processor is connected to the second modem processor.

The first modem processor is used to acquire a message of the first user identification card, and communicate with a first 4G network based on the obtained message of the first user identification card to provide voice service and data service;

The first modem processor is also used to acquire a message of the second user identification card, and communicate with a second 4G network based on the obtained message of the second user identification card to provide voice service;

The second modem processor is used to acquire the message of the second user identification card from the first modem processor, and communicate with the second 4G network based on the obtained message of the second user identification card to provide data service.

In one embodiment, when processing network search and registration, the first modem processor is configured to acquire the message of the first user identification card, and load the corresponding network parameters according to the message of the first user identification card to initiate network search and registration, and thus allow the first user identification card to reside on the CS domain and the PS domain of the 4G network through the first modem processor.

In one embodiment, the first modem processor is configured to acquire the message of the second user identification card, and load the corresponding network parameters according to the message of the second user identification card to process network search and registration, and thus allow the second user identification card to reside on the CS domain of the 4G network through the first modem processor.

In one embodiment, the second modem processor is configured to process network search and registration according to the message of the second user identification card obtained from the first modem processor, and thus allow the second user identification card to reside on the PS domain of the 4G network through the second modem processor.

In one embodiment, the first modem processor includes a data interface, and the second modem processor includes a data interface connected to the data interface of the first modem processor;
the second modem processor acquires the message of the second user identification card through the data interfaces.

In one embodiment, the user device also includes that:
the first application processor is connected to the first modem processor, and configured to provide an interactive interface for receiving user's operation instructions and transmitting the operation instructions to the first modem processor.

In one embodiment, the user device further includes that:
the second application processor is connected to the second modem processor and the first application processor, respectively, and configured to receive the message sent by the first application processor and transparently transmit the message to the second modem processor.

In one embodiment, the first application service processor and the second application service processor are connected to each other through a general-purpose input/output (GPIO) interface.

The user device and the message forwarding method according to the present invention have the following advantages: the second application service processor may have the “routing” function to implement the corresponding message forwarding from the first application service processor, such that the WIFI module may be extended to achieve the WIFI hotspot function, or a function of adding a WIFI data channel may be implemented to improve the user experience; on the other hand, through the intercommunication between the first modem processor and the second modem processor, having two user identification cards reside on the 4G networks may be supported, and thus two 4G channels may be used for concurrent data service transmission to improve the transmission efficiency; in addition, when processing data service transmission, voice service transmission may also be processed to improve the user experience; on the other hand, both user identification cards may be managed by the first modem processor, and thus the management efficiency may be improved.

### BRIEF DESCRIPTION OF THE DRAWINGS

The present invention will be further described in the following with reference to the accompanying drawings and embodiments. In the accompanying drawings:

FIG. 1 illustrates a schematic diagram of a hardware structure of a user device consistent with an embodiment of the present invention;

FIG. 2 illustrates a schematic diagram of a hardware structure of a user device consistent with another embodiment of the present invention;

FIG. 3 illustrates a schematic diagram of the intercommunication between a first modem processor and a second modem processor of a user device consistent with an embodiment of the present invention;

FIG. 4 illustrates a schematic diagram of the format of a data packet consistent with an embodiment of the present invention;

FIG. 5 illustrates a schematic flow chart of a message forwarding method consistent with an embodiment of the present invention.

### DETAILED DESCRIPTION

In order to make the technical features, the objects, and the effects of the present invention more clearly understandable, specific embodiments of the present invention will now be explained in detail with reference to the accompanying drawings.

In the embodiments of the present invention, the 4G networks will be described mainly as LTE networks, other types of 4G networks may also be applicable to the present invention. In subsequent embodiments of the present invention, the first 4G network and the second 4G network may be different networks of different operators, or may be a same network or different networks of a same operator.

### Embodiment 1

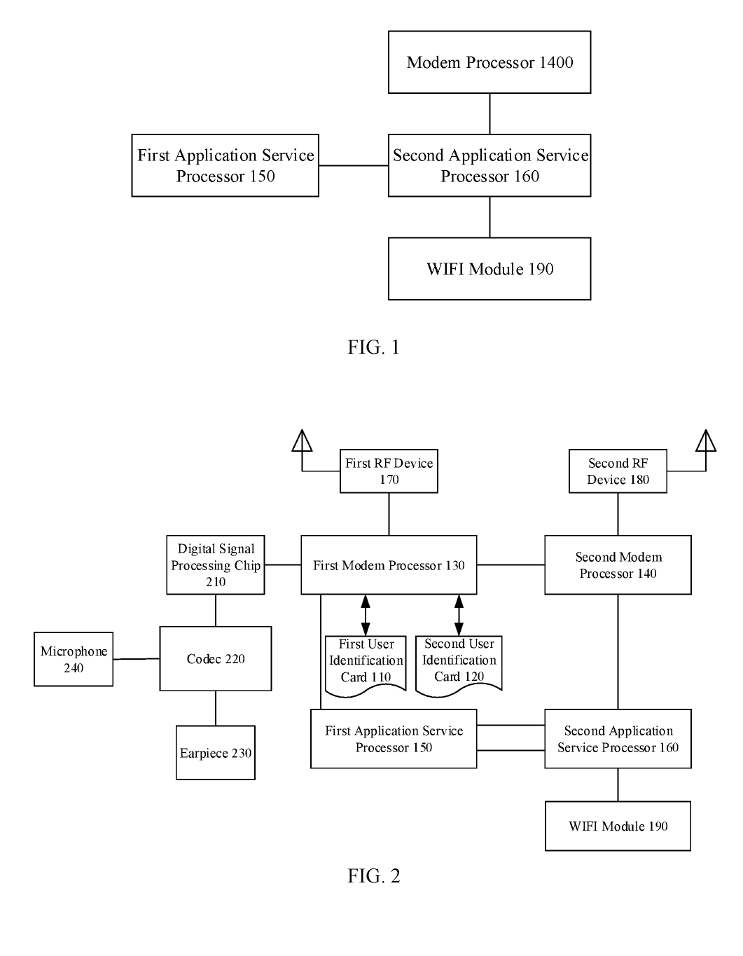

FIG. 1 illustrates a schematic diagram of a hardware structure of a user device consistent with an embodiment of the present invention. In this embodiment, the user device may include a first application service processor 150, a second application service processor 160, a modem processor 1400, and a WIFI module 190. In some embodiments, the user device may include one or more WIFI modules 190.

The first application service processor 150 may be used to process complex logic operations and task allocation to provide the user an interactive interface to transmit user input operation instructions (e.g., operation instructions related to internet or phone calls input by the user through a user interface) to other corresponding modules. The first application service processor 150 may execute the operating system of the user device. The operating system may be stored in a memory, and the operating system may include, but may not be limited to, Windows, Linux, Unix, Mac OS X, IOS, Solaris, Android, etc. The second application service processor 160 may be used to receive the message sent by the first application service processor 150, identify the destination address included in the message, and forward the message to a destination device according to the destination address. In one embodiment of the present invention, the destination device may include the modem processor 1400 and the WIFI module 190 that are connected to the second application service processor 160, respectively.

The WIFI module 190 may process communication based on a WIFI method. In one embodiment of the present invention, the WIFI module may be used to provide a WIFI data channel or may be used as a hotspot (e.g., a WIFI hotspot AP).

The modem processor.

In one embodiment of the present invention, when the WIFI module 190 is used to provide a data channel, the data service transmission may be implemented by the WIFI module 190 and/or the modem processor 1400. In this case, the destination address of the message sent by the first application service processor 150 may include an IP address and a subnet mask. Between the two, the IP address may be an address of an external Internet network, and accordingly, the subnet mask may indicate that the IP address is a remote network. Therefore, the second application service processor 160 may determine that the data service needs to be transmitted to a remote network according to the subnet mask of the destination address, and thus may send the message to the WIFI module 190 and/or the modem processor 1400 that provides the data channel. The modem processor 1400 may process the data, and then a radio frequency (RF) device connected to the modem processor 1400 may send the data out. The WIFI module 190 may process the data and then send the data out.

Specifically, the following three scenarios may be included.

First, the second application service processor 160 may be used to receive the message sent by the first application service processor 150, and forward the message to the modem processor 1400 for data transmission according to the destination address.

Second, the second application service processor 160 may be used to receive the message sent by the first application service processor 150, and forward the message to the WIFI module 190 for data transmission according to the destination address.

Third, the second application service processor 160 may be used to distribute the message to the modem processor 1400 and the WIFI module 190 for concurrent data transmission according to the traffic allocation.

In another embodiment of the present invention, the WIFI module 190 may be used as a hotspot, i.e., the WIFI module 190 may work in an AP mode. In this scenario, the subnet mask in the destination address of the message received by the second application service processor 160 from the first application service processor 150 may have two situations. When the message needs to be processed by the modem processor 1400 before being sent to the external network, the subnet mask may indicate that the IP address is a remote network, and accordingly, the subnet mask may be, for example, in a format of 255.255 . . . . When the message needs to be sent to the WIFI module 190 which serves as a hotspot, the subnet mask may be, for example, in a format of 192.168 . . . . Therefore, whether to send the message to the modem processor 1400 or to send the message to the WIFI module 190 may be determined according to the subnet mask.

Referring to FIG. 2, in one embodiment of the present invention, the user device may further include a first user identification card 110, a second user identification card 120, a first modem processor 130, a second modem processor 140, a first application service processor 150, a second application service processor 160, a first RF device 170, the second RF device 180, a digital signal processing chip 210, a codec 220, an earpiece 230, a microphone 240, etc.

According to the user device, the first user identification card 110 and the second user identification card 120 may be able to manage different users associated with a same technical standard or associated with different technical standards. In a specific but non-limiting example, technical standards may be 2G communication technologies (e.g., GSM, GPRS, EDGE), 3G communication technologies (e.g., WCDMA, TDS-CDMA), 4G communication technologies (e.g., LTE, TD-LTE), or any other mobile communication technologies (e.g., 5G, 4.5G, etc.).

In one embodiment, the first user identification card 110 may store messages used for the communication with a first 4G network. The second user identification card 120 may store messages used for the communication with a second 4G network. Specifically, the user identification cards may store one or more of the following messages: a unique integrated circuit card identifier (ICCID), an international mobile subscriber identity (IMSI), a security authentication and encrypted message, a temporary message related to the local network, a service list accessed by the user, a personal identification number (PIN), and a personal unlocking key (PUK) for unlocking the PIN.

In one embodiment of the present invention, the first modem processor 130 may be used for performing protocol processing, and for modulating and demodulating the sent and the received communication data so that functions such as communication with an external communication device, etc. may be enabled.

The second modem processor 140 may be used for performing protocol processing, and for modulating and demodulating the sent and the received communication data so that functions such as communication with an external communication device, etc. may be enabled.

In one embodiment of the present invention, the protocol processing may include processing protocol stacks of various network formats for network intercommunication, such as the prescribed protocol codes in the communication standards of LTE, WCDMA, GSM, TDSCDMA, 1×, CDMA, EVDO, etc. The protocols of these standards may be what must be complied by the intercommunication between the user device and the operator network (e.g., accessing Internet through data traffic, making phone calls through VOLTE, or making phone calls through CS circuit domains, etc.). In one embodiment of the present invention, because the second modem processor 140 may not process voice services, the protocol stack such as GSM may not be processed.

The first modem processor 130 may include one or more data interfaces, e.g., a GPIO interface, a universal asynchronous receiver-transmitter (UART) interface, a universal serial bus (USB) interface, an inter-integrated circuit (I2C) interface, etc. The second modem processor 140 may also include one or more data transmission interfaces, e.g., a GPIO interface, a UART interface, a USB interface, an I2C interface, etc.

Considering that the downlink speed of a 4G network is relatively fast (150 Mbps), in order to be able to receive and send (without buffering) the data of the second modem processor 140, the high-speed data transmission interface may require sufficient bandwidth and data transmission capability. The USB interface is a high-speed data transmission interface.

The GPIO interface may be used as a status detection interface and the status may be detected according to the high/low level of the voltage or according to pulses. For example, a first processing chip 200 may detect whether a second processing chip 300 is in a crash state according to the high/low state of the voltage level at the status-detection pin.

The UART interface may be a serial communication interface for transmitting basic information, such as control signals, status signals, etc.

The first modem processor 130 may be connected to the first user identification card 120 and the second user identification card 110, respectively through the UART interface to acquire the card message from the first user identification card 110 and the second user identification card 120. In a follow-up section, detailed introduction of the flow for acquiring the card message will be provided.

Moreover, the first modem processor 130 may be connected to the second modem processor 140 through the UART interface such that the card message may be transmitted to the second modem processor 140.

The first modem processor 130 may be implemented through a modem chip, and the second modem 140 may also be implemented through a modem chip.

In one embodiment of the present invention, the network data may be transmitted at a high speed through a high-speed USB data interface to meet the data transmission requirements. When no network data needs to be transmitted, a low-speed data interface with low power consumption may be used for message transmission, such that not only the data transmission may be ensured, but the power consumption may also be saved.

After the first modem processor 130 acquires the message of the first user identification card 110 and the second user identification card 120 through the data interfaces, the first modem processor 130 may process operations such as network search and registration, authentication, etc. according to the obtained message.

Referring to FIG. 2, the first application service processor 150 and the second application service processor 160 may be connected to each other through a GPIO interface and a USB interface. The first RF device 170 and the second RF device 180 may be used to complete signal operations, such as up-conversion, down-conversion, filtering, amplification, transmission, receiving, etc. The wireless access technology that the first RF device 170 and the second RF device 180 are related to may include LTE, GSM, GPRS, and so on.

When the user device processes data service transmission, the operation may be divided into the following situations:
(A) providing data services through the first user identification card

Uplink: the first application service processor 150 may receive a user instruction, and control the first modem processor 130 to process the uplink data according to the user instruction; the first RF device 170 may transmit the uplink data processed by the first modem processor 130 to the first 4G network.

Downlink: the first RF device 170 may receive the downlink data from the first 4G network, and send the received downlink data to the first modem processor 130; the first application service processor 150 may perform operations, such as output, save, etc. on the downlink data processed by the first modem processor 130.
(B) providing data services through the second user identification card

Uplink: the first application service processor 150 may receive a user instruction, and control the second application service processor 160 to send the uplink data (whose destination address is an external network address) to the second modem processor 140; the second modem processor 140 may process the uplink data; the second RF device 180 may transmit the uplink data processed by the second modem processor 140 to the second 4G network.

Downlink: the second RF device 180 may receive the downlink data from the second 4G network, and may send the received downlink data to the second modem processor 140 for processing; the second modem processor 140 may transparently transmit the processed downlink data to the first application service processor 150 through the second application service processor 160, so that operations such as output, save, etc. may be implemented.

In the embodiments of the present invention, because the WIFI module 190 is connected with the second application service processor 160, when the second application service processor 160 receives data (message), the flow direction of the received data may be determined according to the IP address and the subnet mask in the received data. As such, corresponding data forwarding may be implemented. The specific implementation process has been described above and will not be repeated here.
(C) simultaneously providing data services through the first user identification card and the second user identification card

When data services are provided simultaneously through the first user identification card and the second user identification card, the following two conditions may be included.

First, different data services may be provided through the first user identification card and the second user identification card, respectively. In this scenario, two data channels may be used to process the transmission of different data services, and thus the transmission efficiency may be greatly improved.

Second, the same data service may be transmitted simultaneously through the first user identification card and the second user identification card. In this scenario, traffic allocation may be needed. That is, the same data service may be divided into different data blocks and transmitted separately through two data channels. It should be understood that the method can be implemented by dividing the data service equally, or by adjusting the traffic of the two channels according to the quality of the links (rate, delay, etc.).

Referring to FIG. 2, when providing voice services, the digital signal processing chip 210 may be used for audio signal processing, such as echo suppression, noise suppression etc. during a call. The codec 220 may be used for analog-to-digital (A/D) and digital-to-analog (D/A) conversion. The earpiece 230 may be used to output sound signals. The microphone 240 may be used to collect voice signals.

When the user device processes voice service transmission, the operation may include the following:
(A) providing voice service only through the first user identification card

First, a voice communication connection may be established: the first application service processor 150 may transmit the operation instruction to the first modem processor 130, and through a procedure, such as sending a radio resource control (RRC) connection request from the first RF device 170 to the first 4G network, etc., a voice communication connection with the called party may be established.

After the voice communication connection is established, the voice uplink transmission process may be as follows: the microphone 240 may collect voice signals, and the codec 220 may receive the collected voice signals, and transmit the signals to the digital signal processing chip 210 after performing analog-to-digital conversion; the digital signal processing chip 210 may perform audio processing on the received signals, and transmit the processed signals to the first modem processor 130; the first RF device 170 may output the signals processed by the first modem processor 130. The voice downlink transmission process may be as follows: the first RF device 170 may receive the downlink signals and transmit the downlink signals to the first modem processor 130; the digital signal processing chip 210 may perform audio processing on the signals processed by the first modem processor 130 and transmit the signals to the codec 220; the codec 220 may perform digital-to-analog conversion on the received signals and transmit the signals to the earpiece 230.

It should be understood that when the user device is the called party, the process of establishing a voice communication connection may be to receive the connection request of the calling party in order to establish the voice communication connection with the calling party. The subsequent voice uplink transmission and downlink transmission processes may be the same as the processes described above.
(B) providing voice service only through the second user identification card

First, a voice communication connection may be established: the first application service processor 150 may transmit the operation instruction to the first modem processor 130, and through a procedure, such as sending a radio resource control (RRC) connection request from the first RF device 170 to the second 4G network, etc., a voice communication connection with the called party may be established.

After the voice communication connection is established, the voice uplink transmission process may be as follows: the microphone 240 may collect voice signals, and the codec 220 may receive the collected voice signals, and transmit the signals to the digital signal processing chip 210 after performing analog-to-digital conversion; the digital signal processing chip 210 may perform audio processing on the received signals, and transmit the processed signals to the first modem processor 130; the first RF device 170 may output the signals processed by the first modem processor 130. The voice downlink transmission process may be as follows: the first RF device 170 may receive the downlink signals and transmit the downlink signals to the first modem processor 130; the digital signal processing chip 210 may perform audio processing on the signals processed by the first modem processor 130 and transmit the signals to the codec 220; the codec 220 may perform digital-to-analog conversion on the received signals and transmit the signals to the earpiece 230.

It should be understood that when the user device is the called party, the process of establishing a voice communication connection may be to receive the connection request of the calling party in order to establish the voice communication connection with the calling party. The subsequent voice uplink transmission and downlink transmission processes may be the same as the processes described above.
(C) while providing voice service through the first user identification card, providing data service through the second user identification card

In this scenario, the process for providing the voice service through the first user identification card and the process for providing the data service through the second user identification card may be simultaneously implemented according to the description above. The detailed description will not be repeated here.
(D) while providing voice service through the second user identification card, providing data service through the first user identification card

In this scenario, the process for providing the voice service through the second user identification card and the process for providing the data service through the first user identification card may be simultaneously implemented according to the description above. The detailed description will not be repeated here.

In the embodiments of the present invention, the first modem processor 130 may also perform in-position detection on the first user identification card 110 and the second user identification card 120 at regular intervals. Specifically:
the first modem processor 130 may communicate with the first user identification card 110 and the second user identification card 120 once every a predetermined time (for example, 28 seconds) to confirm whether the user identification cards are in place, and thus ensure that the communication is normal. For example, the first modem processor 130 may send a null data to the first user identification card 110 and the second user identification card 120, respectively. When a response is received, the user identification cards may be confirmed to be in place, otherwise the user identification cards may not be in place.

In the embodiments of the present invention, the user device can simultaneously use the data networks of the two user identification cards to download data services at the same time, such that the goal of accelerating dual data concurrent download may be achieved. Therefore, the same user identification card may need to be accessed by both the first modem processor 130 and the second modem processor 140. The term, access, used here may refer to obtaining the messages of the user identification cards to realize the network communication through a first subscription associated with the first user identification card 110 and also realize the network communication through a second subscription associated with the second user identification card 120.

Referring to FIG. 2, in the embodiments of the present invention, the two user identification cards may be connected to the first modem processor 130 in the hardware structure. In one embodiment, the first modem processor 130 may be connected to the first user identification card 110 and the second user identification card 120 respectively through a UART data interface to perform message read and write operations on the first user identification card 110 and the second user identification card 120.

The second modem processor 140 may need to intercommunicate with the first modem processor 130 in order to acquire the message of the user identification cards. Specifically, in one embodiment of the present invention, the first modem processor 130 and the second modem processor 140 may be connected through a data interface (for example, a UART data interface) so that the message of the user identification cards may be transmitted to the second modem processor 140.

In order to realize the intercommunication of the card message between the first modem processor 130 and the second modem processor 140, the communication protocol between the first modem processor 130 and the second modem processor 140 may be divided into a physical layer, a transport layer, and an application layer. Among them, the physical layer may be used for sending and receiving data. The transport layer may be extended to multiple interfaces and may be used for providing different services corresponding to the application layer. The application layer may be used to initiate a service to perform the corresponding message acquisition function.

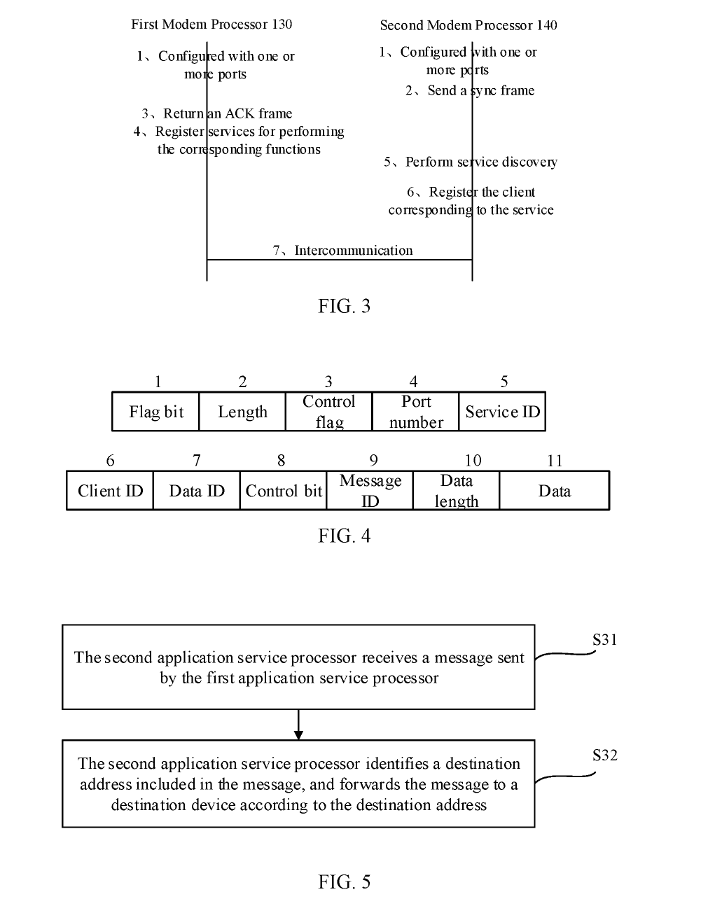

Specifically, referring to FIG. 3, first, the first modem processor 130 and the second modem processor 140 may configure one or more ports, respectively. In one embodiment of the present invention, the ports may be virtual logical ports, and configuring a port may include setting a port number for the port, and so on. According to the functions, the ports may have two types. The first type may be a port that, corresponding to a service registered by the application layer, transmits the message acquired by the application layer to the transport layer. The second type may be a port that, corresponding to a physical interface of the physical layer, transmits the message to the corresponding physical interface to realize the output (or reception) of the message.

Specifically, the first modem processor 130 may register services for performing the corresponding functions. In one embodiment of the present invention, the services may be default services. For example, acquiring the card message may be set as a default service. Accordingly, when a preset condition is satisfied, after the second modem processor sends a sync frame to establish a connection with the first modem processor, the first modem processor may be able to register the default service, and thus perform the function of the default service. In one embodiment of the present invention, the default service may be acquiring the message of the user identification card.

In the embodiments of the present invention, different services may have different functions. For example, a service for acquiring card message may be registered. In the embodiments of the present invention, other types of services, such as services for acquiring status information, control information, etc. may also be registered. Each service may correspond to one port, that is, the message acquired by the service may be transmitted through the port corresponding to the service. The port here may refer to a port of the first type as described above.

Therefore, in the embodiments of the present invention, because a plurality of ports (ports of the first type as described above), corresponding to different services respectively, can be extended, and different transport layers can be called to transmit messages to the interfaces (for example, USB interface, shared memory interface, etc.) of the physical layer according to the actual transmission requirements of the communication, the extension of multiple transport-layer protocols may be supported. For example, for a first service, a transport layer 1 may be called to transmit message, and for a second service, a transport layer 2 may be called to transmit message. Different transport layers may adopt different transport-layer protocols.

The second modem processor 140 may send a sync frame (synchronization frame) to the first modem processor 130; the first modem processor 130 may also be used to return an acknowledgement frame (ACK) after receiving the sync frame, such that a connection may be established between the first modem processor 130 and the second modem processor 140. In the embodiments of the present invention, when the preset condition is satisfied, the second modem processor 140 may initiate a connection process, i.e., sending a sync frame. The preset condition may be an initialization process such starting, rebooting, etc.

It should be understood that in the embodiments of the present invention, there is no specific order of establishing the connection between the first modem processor 130 and the second modem processor 140 through sync and ACK and registering the services by the first modem processor 130. The first modem processor 130 may register the services either before or after the connection is established.

The second modem processor 140 may perform service discovery and may register the client that corresponds to the service. In one embodiment, the client registered by the second modem processor 140 may correspond to the service registered by the first modem processor 130. In addition, the same as the service registered by the first modem processor 130, the client registered by the second modem processor 140 may also correspond to a port, such that the message may be transmitted to the transport layer through the port, and may further be transmitted to the corresponding physical interface through the transport layer.

After the second modem processor 140 registers the client, the first modem processor 130 and the second modem processor 140 may be able to intercommunicate with each other. Specifically, when exchanging messages, a data packet format shown in FIG. 4 may be adopted. The data packet format may include a flag bit (header part), a length (the length of the entire packet), a control flag (indicating whether the data packet is from a client or a server), a port number (local port), a service ID, a client ID, a data ID, a control bit, a messages ID, a data length, and data.

In one embodiment of the present invention, the port number may be a port number of a port of the second type as described above. That is, the port number may be used to indicate which physical interface the data packet is transmitted to. For example, when the physical interfaces include a USB interface and a shared memory interface, the data packet can be correctly transmitted to the corresponding physical interface through the port number so that the intercommunication with the second modem processor 140 may be achieved. Therefore, when the data packet is transmitted to the physical layer, the port number field may be deleted, that is, the port number field may not be included in the data packet transmitted to the corresponding port.

In the embodiments of the present invention, the port numbers of different physical interfaces (hardware interfaces) may be different. Therefore, by specifying the port number in the data packet, the data packet may be correctly forwarded such that the message obtained by the service, which is registered by the application layer, can be sent out through the correct physical interface. Therefore, the dual-core communication device according to the embodiments of the present invention may support the extension of multiple physical interfaces (i.e., the extension of multiple physical-layer protocols).

The service ID may be the ID number of the registered service. The client ID may be the ID number of the client corresponding to the service. The control bit may be used to identify the data packet as a request packet, a reply packet, etc. The data may adopt a type-len-value format, where type is used to represent the type of the entire data block, len is used to represent the size of the value field, and value is the data field.

In one embodiment of the present invention, a service may need to output multiple data packets, and accordingly, the message ID may indicate the sequence number of the output data packet. The data ID may be used to distinguish the message type of the data packet. Each data packet may include multiple different types of data, and thus a message ID may correspond to multiple types. For example, the signal strength, the network format, and other messages may be sent out as a data packet, and the types of different data blocks may be represented by type in the data field. As such, using one data packet to send out various messages in a same message type may be realized.

It should be understood that the data packet format shown in FIG. 4 is merely exemplary and other similar formats may also be used.

In one embodiment of the present invention, specifically, the first modem processor 130 may be configured with a first logical port corresponding to the default service and a second logical port corresponding to the physical interface of the first modem processor. To transmit the message obtained by the default service to the second modem processor through the physical interface of the first modem processor, the message obtained by the default service may be transmitted to the second logical port through the first logical port. The second modem processor 140 may be configured with a third logical port corresponding to the client, and a fourth logical port corresponding to the physical interface of the second modem processor. To transmit the message received by the physical interface of the second modem processor to the client, the message received by the physical interface of the second modem processor may be transmitted to the third logical port through the fourth logical port.

In the embodiments of the present invention, when the second modem processor 140 is shut down or restarts abnormally, the second modem processor 140 may close the corresponding client and port. When the second modem processor 140 returns to normal, through the method of sending a sync frame, a connection with the first modem processor 130 may be re-established to re-execute the processes for service registration, client registration, message exchange, etc.

Similarly, when the first modem processor 130 is shut down or restarts abnormally, the first modem processor 130 may close the corresponding service and port. When the first modem processor 130 returns to normal, through the method of sending a sync frame, a connection with the second modem processor 140 may be re-established to re-execute the processes for service registration, client registration, message exchange, etc.

In the dual-core communication device according to the embodiments of the present invention, a client-server (C/S) communication architecture may be adopted between the first modem processor and the second modem processor for message sharing. As a result, the first modem processor 130 may share the acquired message with the second modem processor 140, so that instant acquisition of the message by the second modem processor 140 may be achieved. Moreover, because different ports are registered for different services to perform the corresponding transmission, extension of multiple transport-layer protocols may be supported; in addition, extension of multiple physical-layer protocols may also be supported.

The user device may include a computer-readable storage medium that includes a set of instructions that, when executed, may cause at least one processor to perform operations including the following: controlling both the first user identification card and the second user identification card to be connected to the first modem processor, and the first modem processor to be connected to the second modem processor.

The first modem processor may be used to acquire a message of the first user identification card, and communicate with a first 4G network based on the obtained message of the first user identification card to provide voice service and data service.

The first modem processor may also be used to acquire a message of the second user identification card, and communicate with a second 4G network based on the obtained message of the second user identification card to provide voice service.

The second modem processor may be used to acquire the message of the second user identification card from the first modem processor, and communicate with the second 4G network based on the obtained message of the second user identification card to provide data service.

After the second modem processor acquires the message of the user identification card by using the above-mentioned user identification card message sharing scheme, network search and registration may be processed.

In one embodiment of the present invention, the first user identification card may be used as a primary card, and the second user identification card may be used as a secondary card. Accordingly, when processing network search and registration, the first modem processor may acquire the message of the first user identification card, and load the network parameters corresponding to the first user identification card according to the acquired message to register the first user identification card in the first network for CS voice service and PS data service. In addition, the first modem processor may also acquire the message of the second user identification card, and load the network parameters corresponding to the second user identification card according to the acquired message to register the second user identification card in the first network for CS voice service.

Further, the computer-readable storage medium may include a set of instructions that, when executed, may cause at least one processor to perform operations including the following: controlling the first modem processor to acquire the first user identification card during network search and registration, and load the corresponding network parameters according to the message of the first user identification card to initiate network search and registration, and thus allow the first user identification card to reside on the CS domain and the PS domain of the 4G network through the first modem processor.

The first modem processor may also send the acquired message of the second user identification card to the second modem processor. The second modem processor may register the second user identification card in the second network for PS data service according to the received message of the second user identification card.

In addition, the second modem processor may also perform read and write operations on the first user identification card and/or the second user identification card.

The computer-readable storage medium may include a set of instructions that, when executed, may cause at least one processor to perform operations including the following the following: controlling the first modem processor to acquire the message of the second user identification card, and load the corresponding network parameters according to the message of the second user identification card to process network search and registration, and thus allow the second user identification card to reside on the CS domain of the 4G network through the first modem processor; and controlling the second modem processor to acquire the message of the second user identification card from the first modem processor to process network search and registration, and thus allow the second user identification card to reside on the PS domain of the 4G network through the second modem processor.

The first modem processor may include a data interface, and the second modem processor may include a data interface connected to the data interface of the first modem processor. The computer-readable storage medium may be configured to control the second modem processor to acquire the message of the second user identification card through the data interfaces.

The computer-readable storage medium may include a set of instructions that, when executed, may cause at least one processor to perform operations including the following: connecting a first application processor to the first modem processor to provide an interactive interface for receiving user's operation instructions and transmitting the operation instructions to the first modem processor.

The user device may also include a second application processor. The computer-readable storage medium may include a set of instructions that, when executed, may cause at least one processor to perform the following operations: connecting the second application processor to the second modem process and the first application processor for receiving the message sent by the first application processor and transparently transmitting the message to the second modem processor.

For the user device according to the embodiments of the present invention, the second application service processor may have the “routing” function to implement the corresponding message forwarding from the first application service processor, such that the WIFI module may be extended to achieve the WIFI hotspot function, or a function of adding a WIFI data channel may be implemented to improve the user experience; on the other hand, through the intercommunication between the first modem processor and the second modem processor, having two user identification cards reside on the 4G networks may be supported, and thus two 4G channels may be used for concurrent data service transmission to improve the transmission efficiency; in addition, when processing data service transmission, voice service transmission may also be processed to improve the user experience; on the other hand, both user identification cards may be managed by the first modem processor, and thus the management efficiency may be improved.

FIG. 5 illustrates a schematic flow chart of a message forwarding method consistent with an embodiment of the present invention. Referring to FIG. 5, the message forwarding method may include that:

S31, the second application service processor receives a message sent by the first application service processor;

S32, the second application service processor identifies the destination address included in the message, and forwards the message to a destination device according to the destination address.

In one embodiment, the destination device may include a modem processor connected to the second application service processor, a WIFI module connected to the second application service processor. The destination address may include an IP address and a subnet mask.

In one embodiment, the WIFI module may provide a WIFI data channel, or may be used as a WIFI hotspot. When the WIFI module is used to provide a WIFI data channel (that is, work in a STA mode), the second application service processor may receive the message sent by the first application service processor, and forward the message to the modem processor for data transmission according to the destination address; or the second application service processor may receive the message sent by the first application service processor, and forward the message to the WIFI module for data transmission according to the destination address; or the second application service processor may distribute the message to the modem processor and the WIFI module for concurrent data transmission according to the traffic allocation.

When the WIFI module is used as a hotspot, the second application service processor may determine whether to send the message to the modem processor or to send the message to the WIFI module according to the subnet mask in the destination address. When the message needs to be sent to the WIFI module, the WIFI module may provide a hotspot function.

It should be understood that the details and principles in the above description of the user device should also apply to the message forwarding method according to the embodiments, and the details are not repeated here.

For the user device and the message forwarding method according to the embodiments of the present invention, the second application service processor may have the “routing” function to implement the corresponding message forwarding from the first application service processor, such that the WIFI module may be extended to achieve the WIFI hotspot function, or a function of adding a WIFI data channel may be implemented to improve the user experience; on the other hand, through the intercommunication between the first modem processor and the second modem processor, having two user identification cards reside on the 4G networks may be supported, and thus two 4G channels may be used for concurrent data service transmission to improve the transmission efficiency; in addition, when processing data service transmission, voice service transmission may also be processed to improve the user experience; on the other hand, both user identification cards may be managed by the first modem processor, and thus the management efficiency may be improved.

The user device may include any mobile, portable computing or communication device that can be connected to network, such as a cellular device. For example, the user device may be a cell phone (mobile phone), a navigation system, a computing device, a camera, a PDA, a music device, a gaming device, or a handheld device with wireless connectivity.

In the embodiments of the present invention, unless otherwise specified, the term “plurality” refers to two or more than two. In the description of the present invention, it should be understood that the terms “first”, “second”, etc. are used for descriptive purposes only and are not to be construed as indicating or implying relative importance.

Any process or method described in the flowcharts or described in other ways in the embodiments of the present invention may be understood as comprising one or more modules, segments, or sections of executable instruction code for implementing the steps of a specific logic function or process. In addition, the scope of the embodiments of the present invention include additional implementations, in which functions may be performed in an order different from the order shown or discussed, including a substantially simultaneous manner or a reverse order depending on the functionality involved. This should be understood by those skilled in the art according to the described embodiments of the present invention.

For illustrative purposes, the foregoing description uses specific terms to provide a thorough understanding of the present invention. However, it will be apparent to those skilled in the art that specific details may not be required in order to implement the invention. The foregoing description of specific embodiments of the invention has been presented for the purposes of illustration and description. They are not intended to be exhaustive or to limit the invention to the precise forms disclosed. In view of the above principles, many modifications and variations are possible. These embodiments are shown and described in order to best explain the principles of the invention and its practical applications, thereby enabling others skilled in the art to best utilize various embodiments of the present invention and modifications that are suitable for intended specific uses. It is intended that the scope of the invention is defined by the following claims and their equivalents.

Those of ordinary skill in the art may understand that all or part of the steps in the method according to the above embodiments may be implemented by using a program to control the related hardware. The program may be stored in a computer-readable storage medium, and the storage medium may be a ROM/RAM, a disk, a CD, etc.

It should be understood that the above are merely the preferred embodiments of the present invention, and thus may not limit the scope of the patent of the present invention. Any direct or indirect application of equivalent structures or equivalent processes transformed according to the description and the accompanying drawings of the present invention in other related technical fields may also be included in the scope of patent protection of the present invention.

In the several embodiments provided in this application, it should be understood that the disclosed device and method can be implemented in other ways. The embodiments of the device described above are only schematic. For example, the units are only divided according to the logical functions. In actual implementation, other division manners may be adopted. For example, multiple units or components may be combined together, or may be integrated into another system, or some features can be ignored or not performed. In addition, the displayed or discussed interaction, direct coupling, or communication connection between different components may be through some interfaces, indirect coupling, or communication connection of the devices or units, and may be electrical, mechanical, or other forms.

The units described as separate parts may be or may not be physically separated, and the parts displayed as units may be or may not be physical units. That is, the parts may be located in one place, or may be distributed on multiple network units. Some or all of the units may be selected according to actual needs to implement the schemes of the embodiments.

In addition, functional units in the embodiments of the present invention may all be integrated in one processing module. Alternatively, each unit may be separately used as a unit, or two or more units may be integrated in one unit. The integrated unit described above may be implemented either in the form of hardware or in the form of hardware plus software functional units.

Those of ordinary skill in the art should understand that all or part of the steps for implementing the above embodiments of the method can be accomplished by program-instruction related hardware. The program described above may be stored in a computer-readable storage medium, and when the program is executed, steps including the above embodiments of the method may be performed. The storage medium described above may include various media that are able to store program code, including: a mobile storage device, a read-only memory (ROM), a random access memory (RAM), a magnetic disk, an optical disk, etc.

The descriptions above are merely specific implementation manners of the present invention, but the protection scope of the present invention is not limited thereto. Changes or replacements that those skilled in the art can easily think of within the technical scope disclosed by the present invention should be covered by the protection scope of the present invention. Therefore, the protection scope of the present invention shall be subject to the protection scope of the claims.

### INDUSTRIAL APPLICABILITY

The present invention provides a user device and a message forwarding method. Through the second application service processor, a “routing” function may be enabled to implement the corresponding message forwarding from the first application service processor, such that the WIFI module may be extended to achieve the WIFI hotspot function, or a function of adding a WIFI data channel may be implemented to improve the user experience; on the other hand, through the intercommunication between the first modem processor and the second modem processor, having two user identification cards reside on the 4G networks may be supported, and thus two 4G channels may be used for concurrent data service transmission to improve the transmission efficiency. In addition, when processing data service transmission, voice service transmission may also be processed to improve the user experience; on the other hand, both user identification cards may be managed by the first modem processor, and thus the management efficiency may be improved.

1. A message forwarding method, applied to a user device including a first application service processor and a second application service processor, comprising:
receiving a message sent by the first application service processor through the second application service processor;
identifying a destination address included in the message, and forwarding the message to a destination device according to the destination address.

2. The message forwarding method according to claim 1, wherein the destination device includes a modem processor connected to the second application service processor, a WIFI module connected to the second application service processor.

3. The message forwarding method according to claim 2, wherein the destination address includes an IP address and a subnet mask.

4. The message forwarding method according to claim 3, wherein the WIFI module provides a WIFI data channel.

5. The message forwarding method according to claim 4, wherein the method further includes:
receiving, by the second application service processor, the message sent by the first application service processor, and forwarding the message to the modem processor for data transmission according to the destination address; or
receiving, by the second application service processor, the message sent by the first application service processor, and forwarding the message to the WIFI module for data transmission according to the destination address; or
distributing, by the second application service processor, the message to the modem processor and the WIFI module for concurrent data transmission according to traffic allocation.

6. The message forwarding method according to claim 3, wherein the WIFI module is used as a hotspot.

7. The message forwarding method according to claim 6, wherein the second application service processor determines whether to send the message to the modem processor or to send the message to the WIFI module according to the subnet mask in the destination address.

8. A user device, comprising a first application service processor and a second application service processor, wherein:
the first application service processor is configured to send a message to the second application service processor;
the second application service processor is configured to receive the message sent by the first application service processor, identify a destination address included in the message, and forward the message to a destination device according to the destination address.

9. The user device according to claim 8, wherein the destination device includes a modem processor connected to the second application service processor, a WIFI module connected to the second application service processor.

10. The user device according to claim 9, wherein the destination address includes an IP address and a subnet mask.

11. The user device according to claim 10, wherein the WIFI module provides a WIFI data channel.

12. The user device according to claim 11, wherein the second application service processor is configured to perform at least one of:
receiving the message sent by the first application service processor, and forwarding the message to the modem processor for data transmission according to the destination address;
receiving the message sent by the first application service processor, and forwarding the message to the WIFI module for data transmission according to the destination address;
distributing the message to the modem processor and the WIFI module for concurrent data transmission according to traffic allocation.

13. The user device according to claim 8, wherein the user device further includes:
a first user identification card;
a second user identification card;
a first modem processor; and
a second modem processor;
wherein:
both the first user identification card and the second user identification card are connected to the first modem processor, and the first modem processor is connected to the second modem processor;
the first modem processor is used to acquire a message of the first user identification card, and communicate with a first 4G network based on the obtained message of the first user identification card to provide voice service and data service;
the first modem processor is also used to acquire message of the second user identification card, and communicate with a second 4G network based on the obtained message of the second user identification card to provide voice service;
the second modem processor is used to acquire the message of the second user identification card from the first modem processor, and communicate with the second 4G network based on the obtained message of the second user identification card to provide data service.

14. The user device according to claim 13, wherein:
the first modem processor acquires the message of the first user identification card, and loads corresponding network parameters according to the message of the first user identification card to initiate network search and registration, and allows the first user identification card to reside on a CS domain and a PS domain of the first 4G network through the first modem processor.

15. The user device according to claim 13, wherein:
the first modem processor acquires the message of the second user identification card, and loads corresponding network parameters according to the message of the second user identification card to initiate network search and registration, and allows the second user identification card to reside on a CS domain of the second 4G network through the first modem processor.

16. The user device according to claim 13, wherein:
the second modem processor processes network search and registration according to the message of the second user identification card obtained from the first modem processor, and allows the second user identification card to reside on a PS domain of the second 4G network through the second modem processor.

17. The user device according to claim 13, wherein:
the first modem processor includes a data interface, and the second modem processor including a data interface connected to the data interface of the first modem processor;
the second modem processor acquires the message of the second user identification card through the data interfaces.

18. The user device according to claim 13, wherein:
the first application service processor is connected to the first modem processor and provides an interactive interface, and
the first application service processor receives user's operation instructions and transmitting the operation instructions to the first modem processor.

19. The user device according to claim 13, wherein the user device also includes the second application service processor; the computer-readable storage medium includes a set of instructions that, when executed, cause following operations to be performed:
the second application service processor, which is connected to the second modem processor and the first application service processor, receiving the message sent by the first application service processor and transparently transmitting the message to the second modem processor.

20. The user device according to claim 13, wherein the first application service processor and the second application service processor are connected with each other through a general-purpose input/output (GPIO) interface.
